(19) United States
(12) Patent Application Publication
(10) Pub. No.: US 2009/0090010 A1
(43) Pub. Date: Apr. 9, 2009

(54) Pruners with replaceable accessory

(76) Inventor: Chong-Jiang Lin, Taichung Hsien (TW)

Correspondence Address: Dr. BANGER SHIA, 102 Lindencrest Ct., Sugar Land, TX, 77479-5201, US

(21) Appl. No.: 12/334,438

(22) Filed: Dec. 12, 2008

Related U.S. Application Data
(63) Continuation-in-part of application No. 11/418,060, filed on May 5, 2006.

(51) Int. Cl. B26B 13/22

(52) U.S. Cl. 30/254; 30/233; 30/341

(57) ABSTRACT

A pair of pruners and its replaceable accessory in which the pair of pruners includes two blades with two handles integrally connected thereto. The two handles are pivotably connected with each other, and one of the two handles has an insertion port and a snapping portion on two ends thereof. The replaceable accessory is connected to the insertion port and can be a finger protection member, an end piece or a function part. A key is connected to one of the two handles so as to control the width that the two blades can be opened.

This application is a continuation of part of U.S. patent application Ser. No. 11/418,060, which claims the benefit of the earlier filing date of May 5, 2006. Claim 1-2 of this application are amended from previous claim 1, 5, 8, 14 by replacing “finger protection member, end piece, function part and key” with “accessory”, claim 3-4 of this application correspond to the previous claim 5-7 of the U.S. patent application Ser. No. 11/418,060, claim 5 of this application corresponds to the previous claim 3 of the U.S. patent application Ser. No. 11/418,060, claims 6-8 of this application correspond to the previous claims 1-4 of the U.S. patent application Ser. No. 11/418,060, claims 9-10 of this application correspond to the previous claims 9 of the U.S. patent application Ser. No. 11/418,060, claims 11-16 of this application correspond to the previous claims 8-13 of the U.S. patent application Ser. No. 11/418,060, claim 17 of this application corresponds to the previous claim 15 of the U.S. patent application Ser. No. 11/418,060, and claims 18-19 of this application correspond to the previous claims 14-16 of the U.S. patent application Ser. No. 11/418,060.

### BACKGROUND OF THE INVENTION

1. Field of the Invention

The present invention relates to a pair of pruners and its replaceable accessory which is easy to be assembled to the pair of pruners.

2. Description of the Prior Art

A conventional pair of pruners generally includes two blades and two handles which are pivotably connected with each other. Some of the blades are designed to have special shapes so as to cut the plants with less effort. Some conventional pruners provide enhanced mechanism to increase the cutting force. Some pruners include a hanging mechanism which allows the users to hang the pruners on a wall or to be attached to the user's belt. Nevertheless, all of the conventional pruners in the market have a fixed function and which is not changeable. In other words, the users have to prepare another type of tools such as a screw driver when using the pruners in gardens and need a screw driver to tighten or loosen some screws.

The present invention intends to provide a pair of pruners which includes a replaceable accessory which can be a blade, a screw driver bit or any known tools so that the pruners have at least two different functions.

### SUMMARY OF THE INVENTION

The present invention relates to a pair of pruners and its replaceable accessory, the pair of pruners includes two blades and two handles are integrally connected to the two blades. The two handles are pivotably connected with each other, and one of the two handles has an insertion port. The replaceable accessory is connected to the insertion port and can be a finger protection member, an end piece or a function part. The finger protection member has an engaging end for being engaged with the insertion port, and a hooking end for being connected to a snapping portion of the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pair of pruners of the present invention;

FIG. 1-1 is a partial view illustrating a distal end of one of the handles of the pair of pruners of the present invention;

FIG. 2 is a perspective view to show one of the two handles of the pruners of the present invention;

FIG. 3 shows a finger protection member is connected to one of the handles;

FIG. 4 is a cross sectional view to show that the finger protection member is connected to one of the handles;

FIG. 5 shows that the end piece is connected to one of the tow handles, and

FIG. 6 shows the function part to be connected to one of the tow handles.

### DETAILED DESCRIPTION OF THE PREFERRED EMBODIMENT

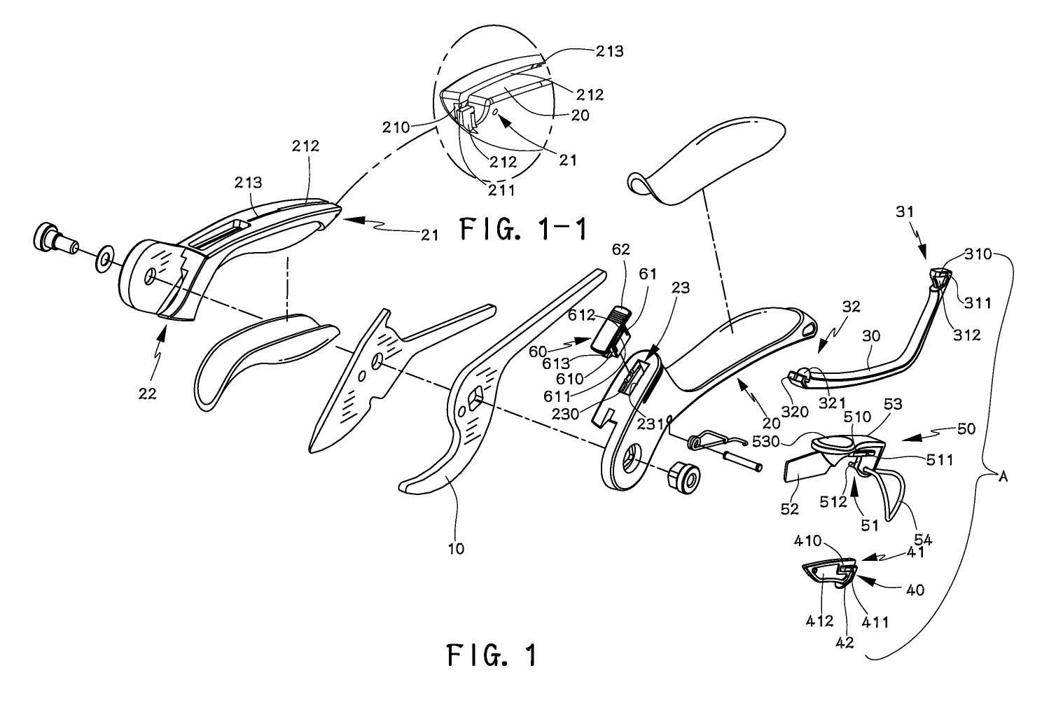

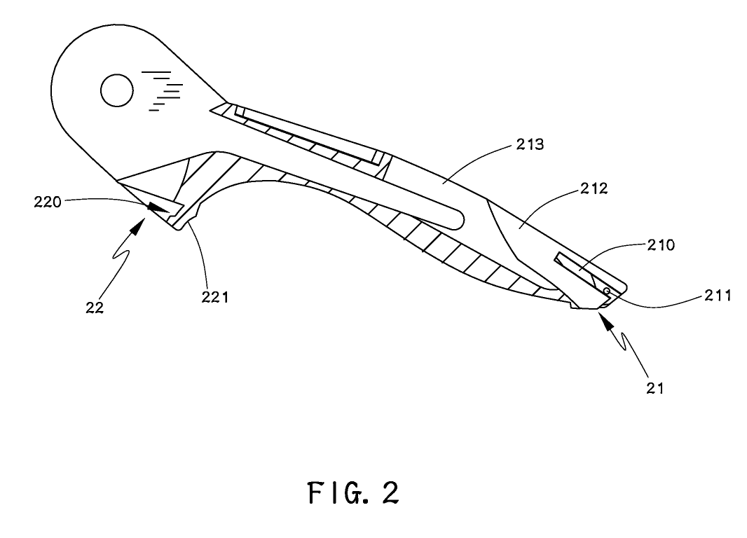

Referring to FIGS. 1 to 4, the pruners of the present invention comprise two blades 10 and two handles 20 that are integrally connected to the two blades 10. The two handles 20 are pivotably connected with each other by a pin so that when the two handles 20 are pivoted toward each other, the two blades 10 are moved toward each other to cut objects. One of the two handles 20 has an insertion port 21 and a triangular snapping portion 22 on two ends thereof. As shown in FIG. 1-1, when viewing from the distal end of the handle 20, the insertion port 21 of the handle 20 is in the form of a cross-slot that penetrates into the distal end of the handle 20. The insertion port 21 of the handle 20 essentially includes a recess 210 that transversely penetrates the distal end of the handle 20 and is quinquangular in cross section, and the recess 210 has two concave positioning portions 211 in two inside walls thereof. A space 212 is defined in the handle 20 at the end having the insertion port 21 and communicates with a narrow tool space 213.

The replaceable accessory can be removably connected to the insertion port 21 as needed. The replaceable accessory can be a finger protection member 30, an end piece 40 or a function part 50.

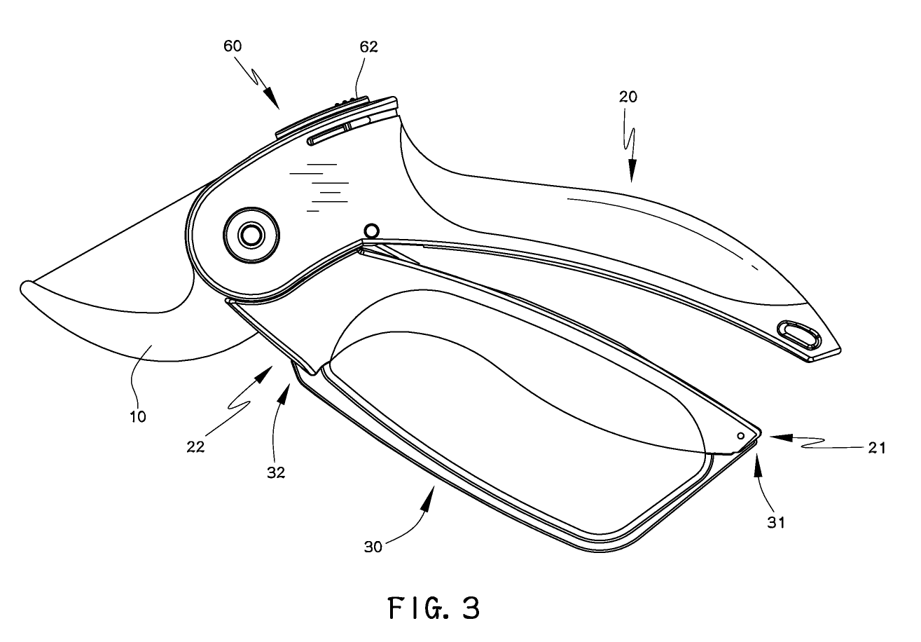

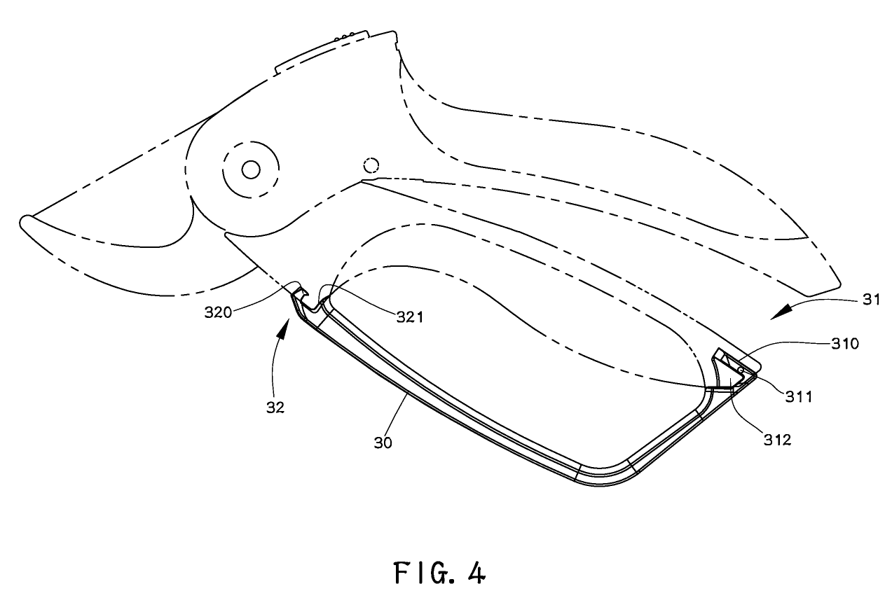

The finger protection member 30 has an engaging end 31 and a hooking end 32. The engaging end 31 includes a protrusion 310 and two convex positioning portions 311 are defined on two sides of the protrusion 310. The protrusion 310 is inserted into the recess 210 of the handle 20 and the two convex positioning portions 311 are engaged with the concave positioning portions 211. The snapping portion 22 of the handle 20 includes a concavity and a notch 220 is defined in an inner end of the concavity. A matching contour 221 is defined in an outside of the concavity and located corresponding to the notch 220. The hooking end 32 of the finger protection member 30 includes a hook 320 and a matching part 321, wherein the hook 320 is hooked with the notch 220 of the snapping portion 22 of the handle 20 and the matching part 321 is engaged with the matching contour 221. The finger protection member 30 is easily to be assembled to the handle 20 for protecting user's the fingers when using the pruners, as shown in FIGS. 3-4. The positioning portions 211, 311 are configured to be oppositely assembled in a convex/concave engagement manner, namely the positioning portions 211 of the handle 20 are convex while the positioning portions 311 of the finger protection member 30 are concave, or vice versa.

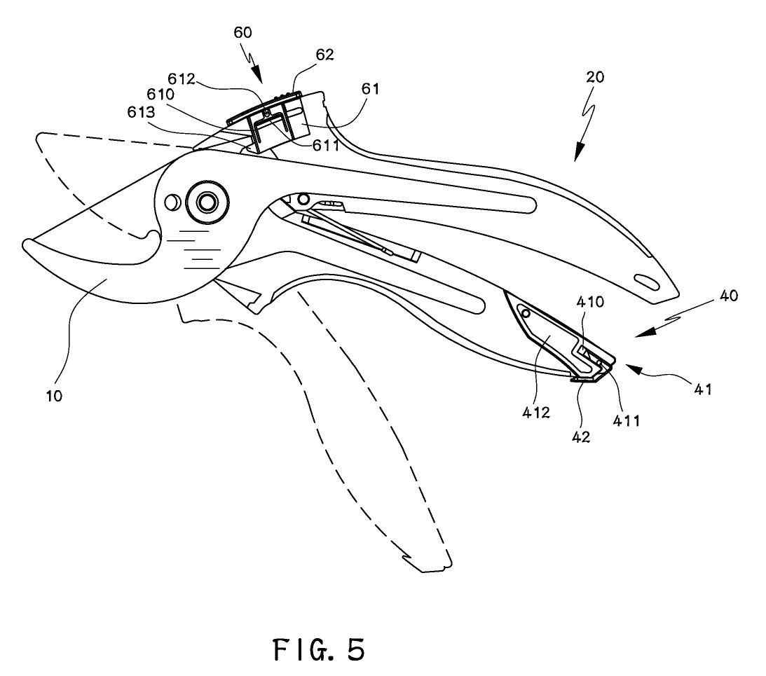

Referring to FIG. 5, the end piece 40 includes an engaging end 41 which includes a protrusion 410 and convex positioning portions 411 are defined on two sides thereof. The engaging end 41 is engaged with the recess 210 of the insertion port 21 of the handle 20, and the convex positioning portions 411 are engaged with the concave positioning portions 211. A cover 42 is connected to the end piece 40 so as to cover the insertion port 21.

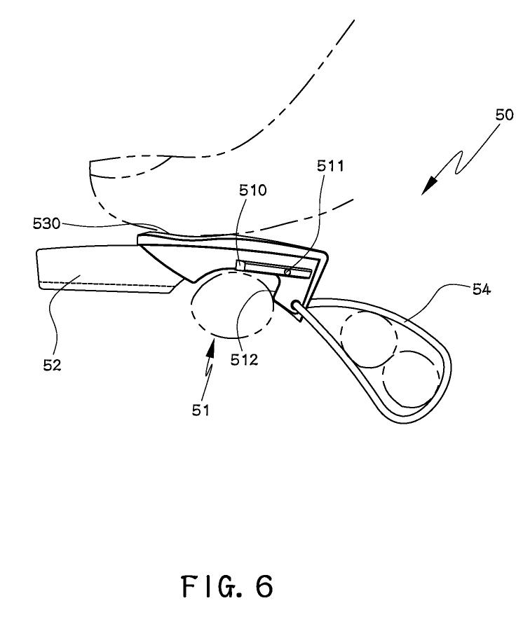

As shown in FIG. 6, the function part 50 is to be connected to the insertion port 21 and includes an engaging end 51 which has a protrusion 510 with two convex positioning portions 511 defined on two sides thereof. The protrusion 510 has an insertion 512 which is inserted into the insertion port 21. A tool head 52 extends from the insertion 512 of the protrusion 510 of the function part 50 and the tool head 52 extends toward the tool space 213 in the handle 20. The insertion 512 of the function part 50 has a cover 53 to seal the insertion port 21. The tool head 52 can be a keystone tip, a blade or any known function tip. The cover 53 has a friction surface 530 and the cover 53 has a flexible collar 54 connected thereto. The user may insert two fingers into the collar 54 and use the thumb to push on the friction surface 530 to operate the tool head 52.

Referring to FIGS. 1 and 5, the other one of the two handles 20 has a keyway 23 which is a rectangular recess and a key 60 is movably engaged with the keyway 23. The keyway 23 in the handle 20 includes dents 230 defined in two inside walls thereof and the dents 230 are orientated in vertical position. Two sliding portions 231 are defined in the two inside walls of the keyway 23 and orientated in horizontal direction. The key 60 includes two ridges 611 and positioning bosses 612 on two sides thereof. The ridges 611 are removably engaged with sliding portions 231 of the handle 20 and the positioning bosses 612 are removably engaged with dents 230 in the handle 20. The key 60 has a rectangular body 61 which has a pushing end 62 on one end of the body 61. The body 61 includes slits 610 defined in two sides thereof and the ridge 611 and the positioning bosses 612 are on the two sides of the body 61. The other end of the body 61 has a stop end 613.

The engagement between the ridges 611 and the sliding portions 231 limits the key 60 to be moved linearly and the engagement between the positioning bosses 612 and the dents 230 provides a click feeling to the user so as to control the width of the opening of the two blades 10. The stop end 613 controls the open and close status of the two blades 10.

While we have shown and described the embodiment in accordance with the present invention, it should be clear to those skilled in the art that further embodiments may be made without departing from the scope of the present invention.

What is claimed is:

1. A pair of pruners and its replaceable accessory, wherein the pair of pruners comprises two blades and two handles which are integrally connected to the two blades, the two handles are pivotably connected with each other, at least one of the two handles has an insertion port and a snapping portion on two ends thereof, and the other of the two handles has a keyway, wherein the insertion port of the handle is in the form of a cross-slot that penetrates into a distal end of the handle, the insertion port of the handle includes a recess that transversely penetrates the distal end of the handle, and the recess has two positioning portions on two inside walls thereof;
the accessory is provided with an engaging end to be engaged to the insertion port, the engaging end is in shape the same as the insertion port, the engaging end includes a protrusion which is in shape the same as the recess of the insertion port of the handle, and two convex positioning portions defined on two sides of the protrusion;
the positioning portions of the pruners and the accessory are assembled to each other in a convex/concave engagement manner.

2. The pair of pruners and its replaceable accessory as claimed in claim 1, wherein when viewing from the distal end of the handle, the insertion port of the handle is in the form of the cross-slot that penetrates into the distal end of the handle, the insertion port of the handle essentially includes the recess that transversely penetrates the distal end of the handle and is quinquangular in cross section, and the recess has two concave positioning portions in two inside walls thereof, a space is defined in the handle at an end having the insertion port.

3. The pair of pruners and its replaceable accessory as claimed in claim 1, wherein the accessory is an end piece, the end piece includes the engaging end to be engaged to the insertion port of the handle, the engaging end of the end piece includes a protrusion and convex positioning portions defined on two sides of the protrusion, the engaging end is engaged with the recess of the insertion port of the handle, and the convex positioning portions are engaged with the concave positioning portions, a cover is connected to the end piece so as to cover the insertion port.

4. The pair of pruners and its replaceable accessory as claimed in claim 2, wherein the accessory is the end piece, the end piece includes the engaging end to be engaged to the insertion port of the handle, the engaging end of the end piece includes the protrusion and convex positioning portions defined on two sides of the protrusion, the engaging end is engaged with the recess of the insertion port of the handle, and the convex positioning portions are engaged with the concave positioning portions, the cover is connected to the end piece so as to cover the insertion port.

5. The pair of pruners and its replaceable accessory as claimed in claim 2, wherein the snapping portion of the handle is triangular in cross section and includes a concavity and a notch defined in an inner end of the concavity, a matching contour is defined in an outside of the concavity and located corresponding to the notch.

6. The pair of pruners and its replaceable accessory as claimed in claim 1, wherein the accessory is a finger protection member, the finger protection member has the engaging end and a hooking end, the engaging end includes the protrusion and two convex positioning portions that are defined on two sides of the protrusion, the protrusion is inserted into the recess of the handle and the two convex positioning portions are engaged with the concave positioning portions, the snapping portion of the handle includes the concavity and the notch defined in the inner end of the concavity, the matching contour is defined in the outside of the concavity and located corresponding to the notch, the hooking end of the finger protection member includes a hook and a matching part, wherein the hook is hooked with the notch of the snapping portion of the handle and the matching part is engaged with the matching contour, the finger protection member is easy to be assembled to the handle for protecting user's the fingers when using the pruners.

7. The pair of pruners and its replaceable accessory as claimed in claim 2, wherein the accessory is the finger protection member, the finger protection member has the engaging end and the hooking end, the engaging end includes the protrusion and two convex positioning portions that are defined on two sides of the protrusion, the protrusion is inserted into the recess of the handle and the two convex positioning portions are engaged with the concave positioning portions, the snapping portion of the handle includes the concavity and the notch defined in the inner end of the concavity, the matching contour is defined in the outside of the concavity and located corresponding to the notch, the hooking end of the finger protection member includes the hook and the matching part, wherein the hook is hooked with the notch of the snapping portion of the handle and the matching part is engaged with the matching contour, the finger protection member is easy to be assembled to the handle for protecting user's the fingers when using the pruners.

8. The pair of pruners and its replaceable accessory as claimed in claim 5, wherein the accessory is the finger protection member, the finger protection member has the engaging end and the hooking end, the engaging end includes the protrusion and two convex positioning portions that are defined on two sides of the protrusion, the protrusion is inserted into the recess of the handle and the two convex positioning portions are engaged with the concave positioning portions, the snapping portion of the handle includes the concavity and the notch defined in the inner end of the concavity, the matching contour is defined in the outside of the concavity and located corresponding to the notch, the hooking end of the finger protection member includes the hook and the matching part, wherein the hook is hooked with the notch of the snapping portion of the handle and the matching part is engaged with the matching contour, the finger protection member is easy to be assembled to the handle for protecting user's the fingers when using the pruners.

9. The pair of pruners and its replaceable accessory as claimed in claim 1, wherein when viewing from the distal end of the handle, the insertion port of the handle is in the form of the cross-slot that penetrates into the distal end of the handle, the insertion port of the handle essentially includes the recess that transversely penetrates the distal end of the handle and is quinquangular in cross section, and the recess has two concave positioning portions in two inside walls thereof, the space is defined in the handle at the end having the insertion port and communicates with a narrow tool space.

10. The pair of pruners and its replaceable accessory as claimed in claim 2, wherein when viewing from the distal end of the handle, the insertion port of the handle is in the form of the cross-slot that penetrates into the distal end of the handle, the insertion port of the handle essentially includes the recess that transversely penetrates the distal end of the handle and is quinquangular in cross section, and the recess has two concave positioning portions in two inside walls thereof, the space is defined in the handle at the end having the insertion port and communicates with the narrow tool space.

11. The pair of pruners and its replaceable accessory as claimed in claim 1, wherein the accessory is a function part to be connected to the insertion port and includes the engaging end which has the protrusion with two convex positioning portions defined on two sides of the protrusion, the protrusion has an insertion which is inserted into the insertion port, a tool head extends from the insertion of the protrusion of the function part and the tool head extends toward the tool space in the handle, the insertion of the function part has a cover to seal the insertion port.

12. The pair of pruners and its replaceable accessory as claimed in claim 9, wherein the accessory is the function part to be connected to the insertion port and includes the engaging end which has the protrusion with two convex positioning portions defined on two sides of the protrusion, the protrusion has the insertion which is inserted into the insertion port, the tool head extends from the insertion of the protrusion of the function part and the tool head extends toward the tool space in the handle, the insertion of the function part has the cover to seal the insertion port.

13. The pair of pruners and its replaceable accessory as claimed in claim 10, wherein the accessory is the function part to be connected to the insertion port and includes the engaging end which has the protrusion with two convex positioning portions defined on two sides of the protrusion, the protrusion has the insertion which is inserted into the insertion port, the tool head extends from the insertion of the protrusion of the function part and the tool head extends toward the tool space in the handle, the insertion of the function part has the cover to seal the insertion port.

14. The pair of pruners and its replaceable accessory as claimed in claim 11, wherein the cover has a friction surface and a flexible collar connected thereto.

15. The pair of pruners and its replaceable accessory as claimed in claim 12, wherein the cover has the friction surface and the flexible collar connected thereto.

16. The pair of pruners and its replaceable accessory as claimed in claim 13, wherein the cover has the friction surface and the flexible collar connected thereto.

17. The pair of pruners and its replaceable accessory as claimed in claim 1, wherein the keyway of the handle is a rectangular recess and includes dents that are defined in two inside walls thereof and are orientated in vertical position, and two sliding portions that are defined in the two inside walls of the keyway and orientated in horizontal direction.

18. The pair of pruners and its replaceable accessory as claimed in claim 1, wherein the accessory is a key including two ridges and positioning bosses on two sides thereof, the ridges are removably engaged with sliding portions of the handle and the positioning bosses are removably engaged with dents in the handle, the key has a rectangular body which has a pushing end on one end thereof, the body includes slits defined in two sides thereof and the ridge and the positioning bosses are on the two sides of the body, the other end of the body has a stop end, an engagement between the ridges and the sliding portions limits the key to be moved linearly and an engagement between the positioning bosses of the key and the dents in the handle provides a click feeling to the user so as to control a width of the opening of the two blades, the stop end controls an open/close status of the two blades.

19. The pair of pruners and its replaceable accessory as claimed in claim 18, wherein the accessory is the key including two ridges and positioning bosses on two sides thereof, the ridges are removably engaged with the sliding portions of the handle and the positioning bosses are removably engaged with the dents in the handle, the key has the rectangular body which has the pushing end on the one end thereof, the body includes slits defined in two sides thereof and the ridge and the positioning bosses are on the two sides of the body, the other end of the body has the stop end, the engagement between the ridges and the sliding portions limits the key to be moved linearly and the engagement between the positioning bosses of the key and the dents in the handle provides the click feeling to the user so as to control the width of the opening of the two blades, the stop end controls the open/close status of the two blades.
